(19) United States
(12) Patent Application Publication
(10) Pub. No.: US 2025/0277314 A1
(43) Pub. Date: Sep. 4, 2025

(54) SYSTEM AND METHODS FOR GROUND BED END OF LIFE PREDICTION

(71) Applicant: Mobiltex Data Ltd., Calgary (CA)

(72) Inventors: Matthew Albert Barrett, Toronto (CA); Mill Jawed, Edmonton (CA); William Philip Maize, Toronto (CA); Antonio Laranjo Da Costa, Calgary (CA)

(21) Appl. No.: 18/591,080

(22) Filed: Feb. 29, 2024

(51) Int. Cl. C23F 13/22; G05B 23/02

(52) U.S. Cl. CPC C23F 13/22; G05B 23/0283

(57) ABSTRACT

A method for predicting end-of-life of an anode ground bed of a cathodic protection system having at least one anode embedded in backfill material includes the steps of acquiring ground bed commissioning data, including anode radius at time of commissioning, ground bed geometry, soil resistivity profile and ground bed backfill data, acquiring resistance values from a rectifier electrically coupled with the anode ground bed, providing a model resistance change over time profile based on the ground bed commissioning data, the model resistance change over time profile including a first trend where resistance values increase gradually and linearly transitioning to a second trend where resistance values increase rapidly and non-linearly, fitting acquired resistance values to the model resistance change over time profile, and, predicting end-of-life of the anode ground bed as a time in the modeled second trend when the predicted resistance change over time profile increases over a predetermined amount.

The present disclosure is directed to a system and methods used for predicting end-of-life of an anode ground bed. More specifically, the present disclosure is directed to a system and methods for predicting end-of-life of an anode ground bed of a cathodic protection system for protecting a metallic structure against corrosion.

### BACKGROUND

Metallic objects embedded in electrolytic media are generally subject to corrosion. Corrosion is a natural process which converts a refined metal into a more chemically stable form such as oxide, hydroxide, or sulfide. Corrosion is a deterioration and destruction of the material making up the metallic object and is caused by electrochemical reactions between the material making up the metallic object and its electrolytic media environment. Moisture, material composition, pH, temperature, and polarization are some of the factors which may influence the rate of corrosion of the metallic structure.

Pipelines which are embedded in soil are subject to corrosive electrochemical forces. Pipeline corrosion can result in damage, which is costly to repair, and which is potentially hazardous to the operation of the pipeline itself. Corroded pipelines can be subject to failure or contamination which can result in the release of potentially hazardous materials into the natural environment.

One method for protecting against pipeline corrosion includes the use of rectifiers, each physically connected to the pipeline, and one or more anodes. Each rectifier protects a section of the pipeline from corrosive activity. In the cathodic protection system, rectifiers are positioned along the length of the pipeline to protect long sections of the pipeline, and preferably the entire pipeline, from corrosive activity. The rectifiers are a source of current external to the pipeline and distribute protective current to the pipeline and drives corrosion to the anodes. However, anodes are slowly consumed over time and must be replaced periodically to ensure that a rectifier can continue to adequately protect the pipeline.

Anodes are typically positioned near the pipeline within a ground bed. The ground bed provides a low-resistance path to ground for the protective current leaving the anodes. Ground bed resistance is an important component of the cathodic protection system. A steady long term resistance trend is desirable from a cathodic protection perspective as this indicates the rectifier-anode-pipeline electrical profile is stable. Many factors on site influence resistance, including anode degradation, drying of the ground bed, formation and growth of holidays in the pipe coating and environmental changes. Soil resistance may be influenced by moisture, temperature, presence of ions and soil type. Seasonal moisture and temperature changes may also be strong drivers of cyclical soil resistance. Depending on when and how these changes manifest, the resistance may gradually or suddenly change over time.

To provide adequate cathodic protection to a buried asset, such as a pipeline, operators measure and monitor various indicators of the performance of the ground bed. These measurements can be done by a technician physically visiting the site, or remotely using a remote monitoring unit (RMU). Replacing or commissioning a new ground bed is a considerable capital project which operators may approach in a variety of ways. Some may elect to replace ground beds before failure, to avoid a time period of insufficient protection. Others may replace the ground bed only after failure occurs. Often replacements involve a comparison of designed service life with the elapsed time since the installation date or commissioning date. This approach ignores relevant datasets and measurements that could provide more insight into the decision to replace the ground bed. In the field of cathodic protection, it is common for measurements to be collected for regulatory purposes only. These measurements are often not compared to related measurements taken at a different cadence (for example, rectifier RMU data with rectifier annual survey data).

It is desired to have a practical approach which combines various related measurements, and which focuses on an actionable result which is the predicted remaining service life of a ground bed. Such an approach would be advantageous as it would allow pipeline operators to better plan and optimize capital spending. By gaining more knowledge of the complex factors involved in a cathodic protection system, operators would be able to strategically schedule ground bed replacements when necessary. The combined data process would allow for additional validation giving operators greater confidence in their decision to replace a ground bed or to wait to do so. Maintaining adequate cathodic protection levels to maximize asset integrity will allow for a reduction in operating expenses and improve the health and safety of employees and the general public.

### BRIEF SUMMARY

The present disclosure is directed to a system and methods used for predicting end-of-life of an anode ground bed. More specifically, the present disclosure is directed to a system and methods for predicting end-of-life of an anode ground bed of a cathodic protection system for protecting a metallic structure against corrosion.

In one aspect, there is provided a method for predicting end-of-life of an anode ground bed of a cathodic protection system having at least one anode embedded in backfill material. The method includes the steps of acquiring ground bed commissioning data, including anode radius at time of commissioning, ground bed geometry, soil resistivity profile and ground bed backfill data, acquiring resistance values from a rectifier electrically coupled with the anode ground bed, providing a model resistance change over time profile based on the ground bed commissioning data, the model resistance change over time profile including a first trend where resistance values increase gradually and linearly transitioning to a second trend where resistance values increase rapidly and non-linearly, fitting acquired resistance values to the model resistance change over time profile, and, predicting end-of-life of the anode ground bed as a time in the modeled second trend when the predicted resistance change over time profile increases over a predetermined amount. In one aspect, end-of-life of the anode may be predicted as a time in the modeled second trend when the modeled resistance change profile approaches infinity. The ground bed geometry may further include ground bed orientation.

The model resistance change over time profile may be provided by inputting the ground bed commissioning data to a model which, based on the ground bed commissioning data, defines the first trend, the second trend and transition therebetween of the model resistance change over time profile.

The end-of-life of the anode ground bed may be output as an end-of-life date corresponding to the time in the modeled second trend when the predicted resistance change over time profile increases over a predetermined amount.

The predicted resistance change over time profile during the modeled first trend transitioning into the modeled second trend has a sinusoidal pattern. In one aspect, the sinusoidal pattern is primarily due to variation of soil temperature local to the ground bed.

Acquiring resistance values may include the steps of acquiring voltage values from the rectifier, acquiring current values from the rectifier, and, calculating the resistance values from the voltage values and the current values using Ohm's Law.

The modeled first trend may be modeled based on resistance values in a first conduction path from an anode surface of the at least one anode through the backfill material and the modeled second trend may be modeled based on resistance values in a second conduction path from the anode surface of the at least one anode to surrounding electrolyte.

In one aspect, there is provided a system for predicting end-of-life of an anode ground bed of a cathodic protection system having at least one anode embedded in backfill material. The system includes a commissioning data acquisition module for acquiring ground bed commissioning data, including anode radius at time of commissioning, ground bed geometry, soil resistivity profile and ground bed backfill data. A resistance value acquisition module may acquire resistance values from a rectifier electrically coupled with the anode ground bed. A profile module may provide a model resistance change over time profile based on the ground bed commissioning data. The model resistance change over time profile may include a first trend where resistance values increase gradually and linearly transitioning to a second trend where resistance values increase rapidly and non-linearly. A fitting module may fit acquired resistance values to the model resistance change over time profile. An end-of-life prediction module may be configured to predict end-of-life of the anode as a time in the modeled second trend when the model resistance change over time profile increases over a predetermined amount. In one aspect, end-of-life of the anode may be predicted as a time in the modeled second trend when the modeled resistance change profile approaches infinity. The ground bed geometry may further include ground bed orientation.

The profile module may be in data exchange communication with a model which receives the ground bed commissioning data as input which, based on the ground bed commissioning data, defines the first trend, the second trend and transition therebetween of the model resistance change over time profile.

End-of-life of the anode ground bed may be output as an end-of-life date corresponding to the time in the modeled second trend when the model resistance change over time profile increases over a predetermined amount.

The model resistance change over time profile during the modeled first trend transitioning into the modeled second trend may have a sinusoidal pattern. In one aspect, the sinusoidal pattern is primarily due to variation of soil temperature local to the ground bed.

The resistance values may be calculated using Ohm's Law from paired voltage values and current values received from the rectifier.

The modeled first trend may be modeled based on resistance values in a first conduction path from an anode surface of the at least one anode through a backfill material and the modeled second trend may be modeled based on resistance values in a second conduction path from the anode surface of the at least one anode to surrounding electrolyte. In one aspect, modeled consumption of the backfill material may result in transition from the modeled first trend to the modeled second trend.

In one aspect, there is provided a method for predicting end-of-life of an anode embedded within a backfill material of a cathodic protection system ground bed. The method includes the steps of acquiring ground bed commissioning data, including anode radius at time of commissioning, ground bed geometry, soil resistivity profile and ground bed backfill data, acquiring resistance values from a rectifier electrically coupled with the anode, providing a model resistance change over time profile based on the ground bed commissioning data, the model resistance change over time profile including a first trend where resistance values increase gradually and linearly transitioning to a second trend where resistance values increase rapidly and non-linearly, fitting acquired resistance values to the model resistance change over time profile, and, predicting end-of-life of the anode as a time in the modeled second trend when the modeled resistance change profile increases over a predetermined amount. End-of-life of the anode may be predicted as a time in the modeled second trend when the modeled resistance change profile approaches infinity. The ground bed commissioning data may include backfill material data.

The sinusoidal pattern is primarily due to variation of soil temperature local to the ground bed. The method may also include where modeled consumption of the backfill material results in transition from the modeled first trend to the modeled second trend.

Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a diagram representing a system in accordance with one or more embodiments;

FIG. 2 illustrates a cathodic protection system for anode ground bed end-of-life prediction in accordance with one or more embodiments;

FIG. 3 illustrates a schematic of modules for anode ground bed end-of-life prediction in accordance with one or more embodiments;

FIG. 4 illustrates a flow diagram depicting a method or process for anode ground bed end-of-life prediction in accordance with one or more embodiments;

FIG. 5 illustrates a plot showing anode rate of decrease over time, in accordance with one or more embodiments;

FIG. 6 illustrates a logarithmic plot of resistance at the ground bed over time, in accordance with one or more embodiments;

FIG. 7 illustrates a plot of seasonal resistivity at the ground bed over time, in accordance with one or more embodiments;

FIG. 8 illustrates a plot of change in resistance over time incorporating the logarithmic plot of FIG. 6 and the plot of seasonal resistivity of FIG. 7, in accordance with one or more embodiments;

FIG. 9 illustrates a plot of anode radius over time in accordance with one or more embodiments; and,

FIG. 10 illustrates a plot of model resistance change over time with acquired resistance values fitted thereto, in accordance with one or more embodiments.

### DETAILED DESCRIPTION

The present disclosure is directed to a system and methods used for predicting end-of-life of an anode ground bed. More specifically, the present disclosure is directed to a system and methods for predicting end-of-life of an anode ground bed of a cathodic protection system for protecting a metallic structure against corrosion.

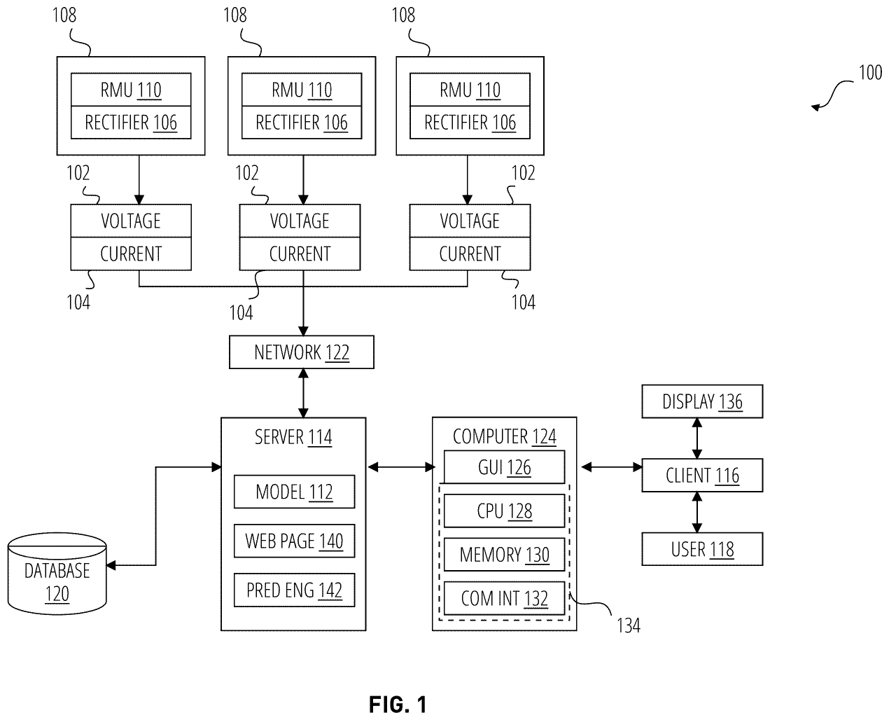

With reference to FIG. 1, there is shown system 100 for collecting voltage values 102 and current values 104 from a rectifier 106 at a rectifier site 108. In FIG. 1, there is shown three rectifier sites 108. However, system 100 may include as few as one rectifier site 108 or any number of rectifier sites 108. Each rectifier site 108 includes a rectifier 106 and a remote monitoring unit 110 (RMU) in data communication with the rectifier 106. The remote monitoring unit 110 receives voltage values 102 and current values 104 from rectifier 106 and transmits the received voltage values 102 and current values 104 to server 114 via network 122. Preferably, data communication between the remote monitoring unit 110 and the server 114 is wireless communication and may be via cellular or satellite communication. Server 114 may represent one or multiple computer systems or server systems. In some implementations, server 114 may be a cloud computing platform.

In one aspect, secure database 120 is in data communication with server 114. Database 120 may store any suitable data thereon for access by database 120. Such data may include stored voltage values 102 and current values 104, predictive outputs of the model 112, rectifier site data, pipeline-anode-ground bed data and/or information which may be generated by, received by or utilized by server 114. Rectifier site data may include geographic data, such as the soil resistivity profile local to the ground bed, the cathodic protection system or components thereof, soil characteristic data, and pipeline-anode-ground bed data. Soil characteristics may be retrieved from public databases such as a national soil database and may include data such as soil order, slope, surface vegetation and drainage characteristics. Ground bed commissioning data which has been input by one or more pipeline operators and stored for later retrieval and may include details such as pipe material, pipe diameter, anode depth, anode radius, anode spacing, ground bed geometry including ground bed orientation, data related to maintenance and human intervention events, ground bed backfill data and rectifier install date or time of commissioning. Also, data relating to weather events, such as periods of unusually high rainfall, floods or droughts or the dates and circumstances of any significant human interventions, such as ground bed or anode maintenance and replacement or any other cathodic protection relevant features related to a rectifier site.

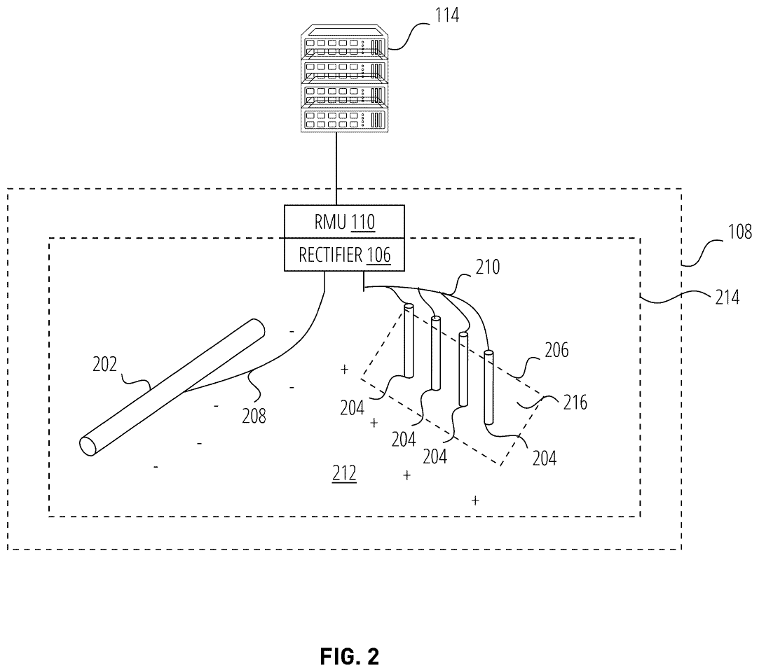

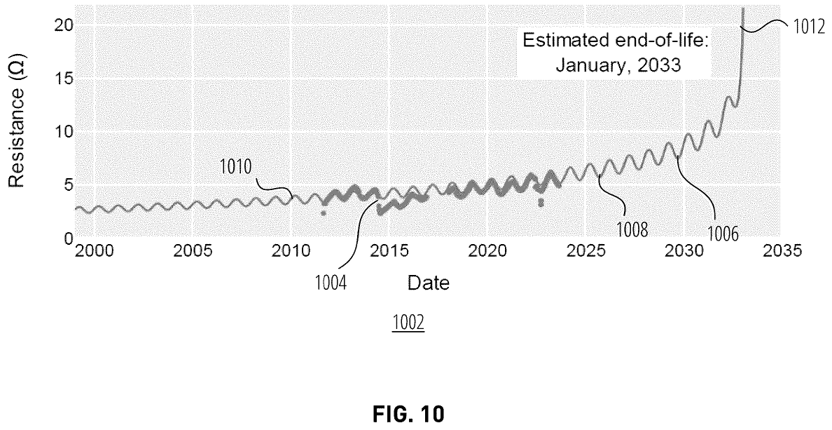

System 100 includes model 112 which is preferably stored on server 114. Model 112 provides a model resistance change over time profile (e.g., 1010 in FIG. 10) based on the ground bed commissioning data of the anode ground bed 206 (see FIG. 2).

System 100 further includes prediction engine 142 which is preferably stored on server 114. Prediction engine 142 is preferably in data exchange communication with model 112. Prediction engine 142 fits resistance values acquired from the rectifier 106 or calculated from the voltage values 102 and current values 104 to the model resistance change over time profile for the corresponding commissioning data. This is used in a manner further described hereinafter to predict end-of-life of an anode of a cathodic protection system using as input voltage values 102 and current values 104 collected from rectifiers 106 or resistance values calculated therefrom.

In communication with server 114 is one or more client devices 116. Client device 116 is accessible by a user 118 such as a pipeline operator. Client device 116 provides a means for the user to interact with data, processes and other components of the server 114. Such interaction may be facilitated by computer system 124 which may be local to the client device 116 or which may be a remote system facilitating communication between the client device 116 and server 114. Client device 116 may receive the outputs of the model 112 or may allow the user 118 to modify the model 112. Client device 116 may be an electronic device such as a desktop computer, a laptop computer, or a mobile device such as a cellular phone, smartphone or tablet computer. Output of the model 112 may be sent directly to the client device 116 or may be stored remotely, such as on a web page 140 hosted by server 114. The user 118 may navigate to the web page 140 to retrieve the output of the model 112. Information provided to client device 116 is visible to the user 118 via display 136.

Computer system 124 may include a controller 134 which may include one or more processors 128, memory 130 configured to store one or more program instructions, and one or more communication interfaces 132.

The processor 128 may include any one or more processing elements, micro-controllers, circuitry, field programmable gate array (FPGA) or other processing systems, and resident or external memory for storing data, executable code, and other information accessed or generated by the controller 134. In this sense, the processor 128 may include any microprocessor device configured to execute algorithms and/or program instructions. The processor 128 is not limited by the materials from which it is formed or the processing mechanisms employed therein and, as such, may be implemented via semiconductor(s) and/or transistors (e.g., using electronic integrated circuit (IC) components), and so forth. In general, the term “processor” may be broadly defined to encompass any device having one or more processing elements, which execute a set of program instructions from a non-transitory memory medium (e.g., memory 130), where the set of program instructions is configured to cause the processor 128 to carry out any of one or more process steps.

Memory 130 may include any storage medium suitable for storing the set of program instructions executable by the associated one or more processors 128. For example, the memory 130 may include a non-transitory memory medium. For instance, the memory 130 may include, but is not limited to, a read-only memory (ROM), a random access memory (RAM), a magnetic or optical memory device (e.g., disk), a magnetic tape, a solid state drive, flash memory (e.g., a secure digital (SD) memory card, a mini-SD memory card, and/or a micro-SD memory card), universal serial bus (USB) memory devices, and the like. The memory 130 may be configured to provide display information to the display 136. In addition, the memory 130 may be configured to store user input information from a user input device of a user interface, such as graphical user interface 126. The memory 130 may be housed in a common controller housing with the one or more processors. The memory 130 may, alternatively or in addition, be located remotely with respect to the spatial location of the processor 128 and/or a controller 134. For instance, the one or more processors 128 and/or the controller 134 may access a remote memory 130 (e.g., server), accessible through a network (e.g., internet, intranet, or other network).

The controller 134 may be configured to perform one or more process steps, as defined by the one or more sets of program instructions. The one or more process steps may be performed iteratively, concurrently, and/or sequentially. The one or more sets of program instructions may be configured to operate via a control algorithm, a neural network (e.g., with states represented as nodes and hidden nodes and transitioning between them until an output is reached via branch metrics), a kernel-based classification method, a Support Vector Machine (SVM) approach, canonical-correlation analysis (CCA), factor analysis, flexible discriminant analysis (FDA), principal component analysis (PCA), multidimensional scaling (MDS), principal component regression (PCR), projection pursuit, data mining, prediction-making, exploratory data analysis, supervised learning analysis, Boolean logic (e.g., resulting in an output of a complete truth or complete false value), fuzzy logic (e.g., resulting in an output of one or more partial truth values instead of a complete truth or complete false value), or the like. For example, in the case of a control algorithm, the one or more sets of program instructions may be configured to operate via proportional control, feedback control, feedforward control, integral control, proportional-derivative (PD) control, proportional-integral (PI) control, proportional-integral-derivative (PID) control, or the like.

The communication interface 132 may be operatively configured to communicate with one or more components of the controller 134. For example, the communication interface 132 may also be coupled (e.g., physically, electrically, and/or communicatively) with the one or more processors 128 to facilitate data transfer between components of the controller 134 and the processor 128. For instance, the communication interface 132 may be configured to retrieve data from the processor 128, or other devices, transmit data for storage in the memory 130, retrieve data from storage in the memory 130, or the like. By way of another example, the controller 134 may be configured to receive and/or acquire data or information from other systems or tools by a transmission medium that may include wireline and/or wireless portions. By way of another example, the controller 134 may be configured to transmit data or information (e.g., the output of one or more procedures of the concepts disclosed herein) to one or more systems or tools by a transmission medium that may include wireline and/or wireless portions (e.g., a transmitter, receiver, transceiver, physical connection interface, or any combination). In this regard, the transmission medium may serve as a data link between the controller 134 and other components or groups of components of system 100. In addition, the controller 134 may be configured to send data to external systems via a transmission medium (e.g., network connection).

With reference to FIG. 2, there is shown a rectifier site 108 in further detail. Rectifier site 108 has a rectifier 106 installed thereon. Remote monitoring unit 110 in is coupled with rectifier 106 data exchange communication therewith. Preferably, rectifier 106 and remote monitoring unit 110 are physically coupled in data exchange communication with one another via a suitable data exchange interface (not shown). Rectifier 106 is electrically coupled with pipeline 202, which is a metallic structure to be protected from corrosion, via one or more electrically conductive cables 208, wires or other suitable electrically conductive coupling. Rectifier 106 is also electrically coupled with one or more anodes 204, via one or more electrically conductive cables 210, wires or other suitable electrically conductive coupling. The electric circuit between pipeline 202 and the one or more anodes 204 is completed by soil 212.

Rectifier 106 is preferably an impressed current rectifier and provides an electric current which counteracts the electrochemical process of corrosion. The one or more anodes 204 and the volume of material surrounding the anodes 204 is referred to as an anode ground bed 206. Anode ground bed 206 provides a medium with a low resistance to ground so that protective current may leave anodes 204 and reach soil 212. The rectifier 106 in electrical communication with pipeline 202 and anodes 204, provides a cathodic protection system 214 for protecting pipeline 202 against corrosion. Pipeline 202 may be continuous and extend over large distances. Accordingly, a plurality of rectifiers 106 may be spaced apart along pipeline 202 to provide cathodic protection along the length of pipeline 202, section by section thereof.

Remote monitoring unit 110 receives and stores voltage values 102 and current values 104 from rectifier 106. Using Ohm's Law, resistance values (not shown) may be obtained by dividing voltage values 102 by corresponding paired current values 104. The voltage values 102, current values 104 and/or resistance values may be captured by remote monitoring unit 110 on a constant basis or at a predetermined frequency, such as hourly, to once weekly. Remote monitoring unit 110 may also store voltage values 102 and current values 104 for a period of time. Remote monitoring unit 110 is in data communication with server 114 and is configured to upload voltage values 102 and current values 104 to server 114. The voltage values 102 and current values 104 may then be stored in secure database 120 for later use or may be input directly into the model 112.

The anode ground bed 206 refers to the arrangement of anodes 204 that are buried in the ground near to pipeline 202. The purpose of anode ground bed 206 is to provide a low-resistance path for the flow of electrical current from the anodes 204 to the surrounding soil 212. The anode ground bed 206 has a backfill 216 which is a material surrounding the anodes 204 that extends the useful life of the anode ground bed 206. Backfill 216 is a highly-conductive, material, such as high carbon content particles, which acts as a low-resistance intermediary between the soil 212 and anodes 204. The choice of material for backfill 216 as well as the design and configuration of the anode ground bed 206 may depend on several factors, such as soil resistivity, conductivity, environmental conditions, and the size of the protected pipeline 202. Various types of materials can be used as ground bed backfill, such as coke breeze, calcined petroleum coke, conductive carbonaceous materials, and other backfill compounds designed for cathodic protection applications. Therefore, anode ground bed 206 serves as an electrical connection between the anodes 204 and soil 212, facilitating efficient distribution of electrical current over a large area. Ground bed orientation or ground bed geometry may depend on several factors, such as soil resistivity, conductivity, environmental conditions, and the size of the protected pipeline 202. Examples of ground bed orientation or ground bed geometry include horizontal/deep, horizontal/shallow, vertical distributed, vertical/deep.

The purpose of anodes 204 is to protect pipeline 202 from corrosion. Corrosion occurs when metal corrodes or degrades due to reactions with its environment, such as moisture or chemicals. Anodes 204 are made of a material that is more easily corroded than the pipeline 202 itself. The spacing and depth of the anodes 204 within the anode ground bed 206 are carefully considered to ensure relatively even or uniform current distribution along the pipeline 202 and to minimize interference with other underground infrastructure (not shown). When connected to the pipeline 202 and to rectifier 106, anodes 204 provide a flow of electrical current through the soil 212 or electrolyte surrounding the pipeline 202. The anodes 204 act as the source of electrons in the electrochemical process. As electrons are released from the anodes 204, they flow through the electrolyte towards the pipeline 202, creating a protective electrical potential on the surface of the pipeline 202. This protective potential helps prevent the corrosion reactions that would otherwise occur. By utilizing anodes 204 in a cathodic protection system 214, the lifespan of pipeline 202 can be extended, reducing maintenance, repair costs, and the risk of leaks or failures due to corrosion.

As shown in FIG. 2, anodes 204 have a cylindrical profile. At time of commissioning of the ground bed, the anodes have a known anode radius and a known anode length. Due to loss of electrons and hence material, the radius of each anode 204 will decrease over time. The anode 204 may also reduce in length, but anode length is not the main driver of anode consumption. Ground bed end-of-life is characterized by a rapid increase in resistance which is often a trigger for ground bed replacement. An end-of-life date is reached when the resistance of the ground bed increases to the point where current passing through the anodes drops significantly.

It should be understood that resistivity in soil 212 surrounding pipeline 202 varies throughout the year. Seasonal variation in soil resistance may be influenced by a variety of environmental factors that occur throughout the year. For example, soil is more compacted and frozen due to colder temperatures in winter. This can result in higher soil resistivity, meaning that the soil offers more resistance to electrical current flow. In warmer seasons like summer, the soil tends to become more dry and less compacted. This can lead to higher soil resistivity, indicating that the soil offers greater resistance to current flow. Soil resistivity can also be influenced by temperature. This is the main factor affecting soil resistance in summer. Other changes such as moisture content or groundwater levels due to rainy seasons, vegetation growth and degradation, freezing and thawing cycles, salinity due to saltwater intrusion or irrigation and natural erosion and deposition, among others, may positively or negatively affect soil resistivity. Changes in soil resistivity can affect the effectiveness of the cathodic protection system 214 in preventing corrosion of pipeline 202.

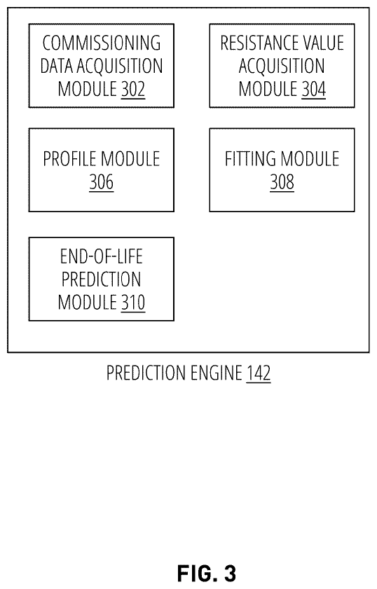

FIG. 3 illustrates prediction engine 142, shown in FIG. 1, in further detail. prediction engine 142 has several modules embedded therein or cooperating therewith. Each module is configured to perform various steps or actions associated with predicting end-of-life of an anode ground bed, as further described herein. In FIG. 1, it is shown that model 112 and prediction engine 142 are both located on server 114 as distinct components. It should be understood that model 112 and prediction engine 142 may be on separate servers in some aspects. In other aspects, model 112 may be a component or module of prediction engine 142.

Commissioning data acquisition module 302 acquires ground bed commissioning data such as anode radius at time of commissioning, ground bed geometry, soil resistivity profile and ground bed backfill data.

Resistance value acquisition module 304 acquires resistance values from a rectifier electrically coupled with the ground bed or calculates the resistance values from paired rectifier voltage values 102 and current values 104. Resistance value acquisition module 304 may, for example, receive rectifier voltage values 102 and current values 104 from remote monitoring unit 110.

Profile module 306 provides a model resistance change over time profile based on the ground bed commissioning data acquired by commissioning data acquisition module 302. The model resistance change over time profile includes a first trend wherein resistance values increase gradually and linearly, the first trend transitioning into a second trend wherein resistance values increase rapidly and non-linearly.

“Model resistance change over time profile” refers to the quantitative characterization of how the resistance of the anode or anode ground bed, as the case may be, varies over time. This profile is derived from a collection of empirical data points, each representing the resistance measured at specific times. It encapsulates the intrinsic behavior of resistance at the anode or anode ground bed under specified conditions, reflecting changes due to factors such as temperature, humidity, or other factors. The ‘model resistance change over time profile’ is not to be confused with its graphical representation, such as a line in a line graph, which serves merely as a visual tool to facilitate the interpretation of the term. Instead, this term denotes the modeled pattern and trends in resistance values as they are expected to evolve over time.

Likewise “first trend”, “second trend” and “transition” are portions of the model resistance change over time profile and also refer to quantitative characterization of how the resistance of the anode or anode ground bed, as the case may be, varies over time. The “first trend”, “second trend” and “transition” therebetween encapsulate intrinsic behavior of resistance at the anode or anode ground bed under specified conditions and are not to be confused with graphical representations thereof, such as trend lines in a line graph, which serve merely as a visual tool to facilitate the interpretation of these terms. Instead, these terms denote portions of the modeled pattern and trends in resistance values as they are expected to evolve over time.

Fitting module 308 fits the resistance values acquired by the resistance value acquisition module 304 to the model resistance change over time profile. Fitting resistance values to the model resistance change over time profile indicates where on the timeline provided by the model resistance change over time profile the anode ground bed currently resides, or more specifically, how much estimated time remains in the anode ground bed lifespan before estimated end-of-life is expected.

End-of-life prediction module 310 predicts end-of-life of the anode and/or the anode ground bed as a time or time period in the modeled second trend when there is a significant increase in resistance in the resistance change profile, such as when the model resistance change over time profile increases over a predetermined amount. In one aspect, the increase is represented as the model resistance change over time profile approaches infinity. Where the predetermined amount is infinite resistance, then infinite measured resistance, or resistance approaching infinity, is deemed to be over the predetermined amount.

In one preferred aspect, the ground bed is a composite anode including the one or more anodes 204 and the backfill 216. The backfill 216 in which the one or more anodes 204 is/are embedded is made of a highly conductive material which increases the effective volume or surface area of the one or more anodes 204. The below method is described in the context of a preferred aspect wherein the ground bed end-of-life is predicted. It should be understood that the method may be applied to one anode of the one or more anodes, all or some anodes of the one or more anodes, or to the composite anode provided by the one or more anodes 204 embedded in the backfill 216. Therefore, the method described herein is useful in predicting end-of-life of single anodes or the net consumption of multiple anodes.

In one aspect, ground bed end-of-life may be estimated by fitting rectifier RMU data to a model 112 of resistance changes over time. Model 112 provides a model resistance change over time profile, represented as 1010 in plot 1002 of FIG. 10, to which resistance values acquired from rectifier or rectifiers 106 may be fit. The resistance at the interface of the anode ground bed 206 and soil 212, is the primary contributor to circuit resistance of a rectifier-anode-pipeline system. The four equations below are commonly used for designing the layout of an array of anodes, considering the different factors such as the size of the anode, the depth below grade, and the resistivity of the local soil. Variations of these equations could be used for different anode geometries.

$${R}_{total} = {R}_{groundbed} + {R}_{cable} + {R}_{pipe - to - soil} + … \\ {R}_{grounded} ≫ {R}_{cable} + {R}_{pipe - to - soil}$$

Assuming

$$L ≫ r , \frac{r}{L} \sim 0$$

and depth>>L in all scenarios:

$${R}_{vertical single} = \frac{ρ}{2 π L} ( ln \frac{4 L}{r} - 1 ) \\ {R}_{horizontal single deep} = \frac{ρ}{2 π L} ( ln \frac{L}{r} )$$

Where Rₜₒₜₐₗ is total resistance, R_{groundbed} is ground bed resistance, R_{cable} is resistance within cable 208 and/or cable 210, Rₚᵢₚₑ₋ₜₒ₋ₛₒᵢₗ is resistance at the pipe-to-soil interface, R_{vertical single} is resistance at a ground bed with vertical single ground bed geometry, R_{horizontal single deep} is resistance at a ground bed with horizontal single deep ground bed geometry, ρ is soil resistivity, L is anode length, and r is anode radius.

In addition, in cases of a distributed ground bed array, additional terms appear in the equation to represent mirroring effect of anodes in the array. These additional terms have no dependence on anode radius, and can be grouped into a single constant, which is represented as the variable C in equation:

$${R}_{vertical distributed} = \frac{ρ}{2 π L} ( ln \frac{4 L}{r} + C )$$

Where R_{vertical single} is for a single anode at shallow depth, R_{horizontal single deep} is for a single anode at deep depth, and R_{vertical distributed} is resistance at a ground bed with vertical distributed ground bed geometry. It should be understood that other equations may be used for other anode layouts.

The model described herein provides an estimate of when the resistance of the ground bed will increase to the point where the current passing through the anodes drops significantly. Preferably, this estimate is a date. Ground bed end-of-life is preceded by a rapid increase in resistance which provides for the end-of-life estimate.

In all anode geometry formulae for resistance, there is a natural logarithm term which arises from the cylindrical geometry of the anode. The main mode of material consumption of the anode results in a reduction of anode radius and the length of the anode is assumed to remain constant over the lifetime of the ground bed. The radius of the anode r is modeled as decreasing over time in a linear fashion, as follows:

$$r ( t ) = {r}_{o} [ 1 - \frac{t - {T}_{commissioning}}{{T}_{end - of - life} - {T}_{commissioning}} ]$$

Where r(t) is the anode radius at time t, rₒ is the anode radius at the time of commissioning, T_{commissioning} is the time of commissioning, T_{end-of-life} is the time of end-of-life of the anode.

At the time of commissioning, this equation reduces to:

$$r ( {T}_{commissioning} ) = {r}_{o} ,$$

and at the end-of-life of the anode:

$$r ( {T}_{end - of - life} ) = 0$$

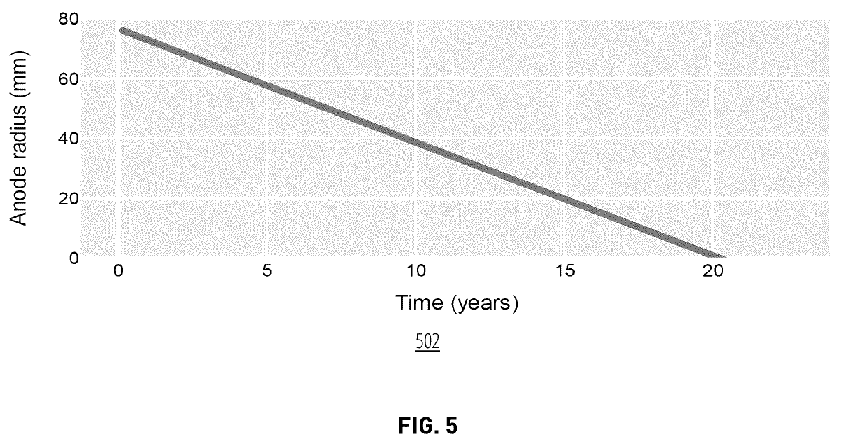

In FIG. 5, there is shown a plot 502 of equation

$$r ( t ) = {r}_{o} [ 1 - \frac{t - {T}_{commissioning}}{{T}_{end - of - life} - {T}_{commissioning}} ]$$

It can be seen that the anode radius decreases linearly from the initial radius of 76 mm to 0 mm after 20 years. Thus, the above formulae result in an anode rate of decrease that is linear. However, the decrease of the anode radius is a complex process, which depends on various contributing factors such as the rate of reaction at the soil-metal interface due to moisture and temperature variations, as well as the rectifier voltage tap settings. The previous equation is modeled linearly, which is a simplification of the physical process.

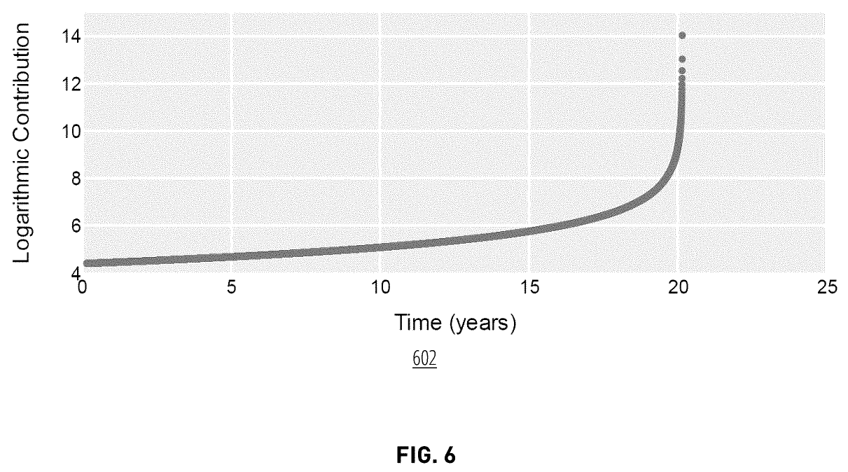

In FIG. 6, there is shown a plot 602 of the logarithmic contribution over time of equation

$${R}_{vertical single} = \frac{ρ}{2 π L} ( ln \frac{4 L}{r} - 1 )$$

As the radius approaches 0 at year 20, the simulated T_{end-of-life}, the natural logarithm increases rapidly until it reaches an undefined value for anode radius=0. If this time-dependent radius is used and fixed values are provided for ρ and L, it can be seen that the resistance changes on longer timescales. The first years of the anode life are relatively stable with a slight increase year over year. As the final years of anode lifetime approach, the effect of the natural logarithm becomes clear, with a dramatic upward trend.

Further, due to seasonal variation, resistivity does not stay constant throughout the year. Factors such as the temperature shifts at different depths, as well as the moisture content of the soil, play a role in the sinusoidal characteristics of the rectifier resistance measurements. The resistivity of the soil is proportional to a sine (or in this case, cosine) function with an amplitude and offset. The variables A, B and φ are site specific and describe the seasonality of the soil resistivity for a particular geographic location, wherein A is the amplitude of seasonal variation of resistivity, B is average resistivity and φ is the time of highest resistivity.

$$ρ ∝ A cos ( 2 π t - φ ) + B$$

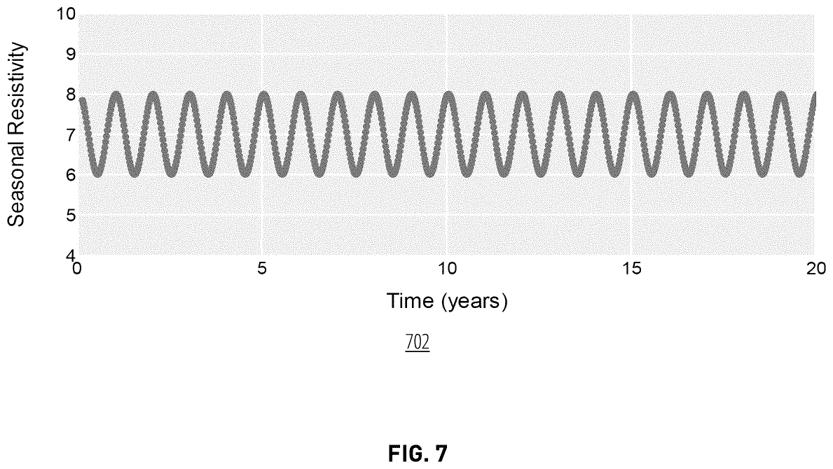

This equation describes seasonal behavior. Inputting resistance values results in a plot 702 of resistivity similar to that shown in FIG. 7, which illustrates a simulated seasonal resistivity profile over 20 years. Temperature changes in soil result in sinusoidal behavior with a period of one year. However, this does not account for long-term trends over the lifetime of the anodes. By multiplying the cosine equation with the natural logarithm equation, a representation is obtained which both describes seasonality and increasing resistance profile over time. The below equation models the time-dependent resistance as measured at a rectifier at any specific calendar date. It should be noted that the below equation is an exemplary equation for a horizontal/deep ground bed geometry and that other ground bed geometries may be accommodated by replacing the variable R(t) with the appropriate ground bed geometry as needed.

$${R}_{horizontal deep} ( t ) = \frac{A cos ( 2 π t - φ ) + B}{2 π L} \cdot [ ln ( \frac{L}{{r}_{o} [ 1 - ( \frac{t - {T}_{commissioning}}{{T}_{end - of - life} - {T}_{commissioning}} ) ]} ) ]$$

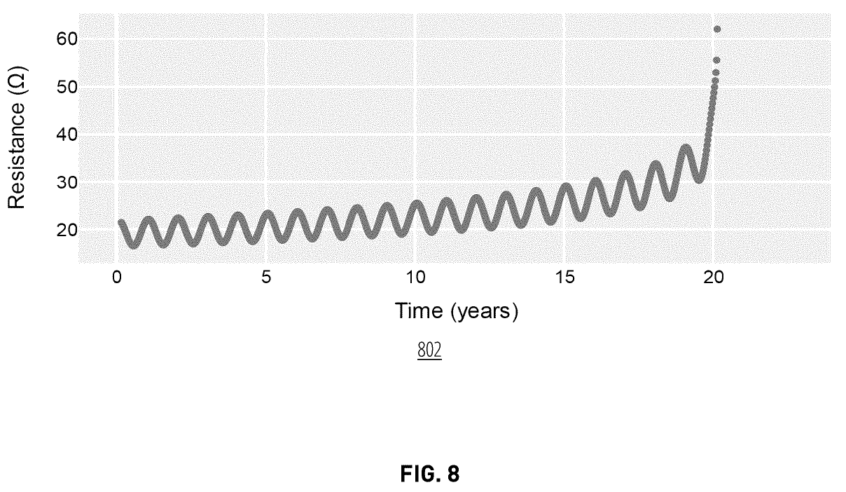

The above equation results in a plot of the resistance profile over time similar to the simulation of this equation shown in plot 802 of FIG. 8.

From the commissioning data, the precise time of commissioning (T_{commissioning}) and rectifier resistance at time of commissioning (R (T_{commissioning}) can be acquired, based on the rectifier voltage values 102 and current values 104 measured on that date. The above equation can be further simplified by expressing the fit parameter Bas a function of A, thus reducing the number of variables in the equation.

$$B = \frac{{R}_{commissioning}}{ln ( \frac{L}{{r}_{o}} )} - A cos ( 2 π {T}_{commissioning} - φ )$$

Additional terms are also included to describe the contribution of the backfill 216 surrounding the anode 204. The model accounts for two time periods relating respectively to two conduction paths in the cathodic protection system in parallel with one another. The first conduction path is the electronic path from the surface of the anodes 204 through the backfill material. The second conduction path is an ionic conduction path from the surface of anodes 204 to the surrounding electrolyte. When the electronic conduction through the backfill dominates in the first time period, the effective size of the conducting volume is larger than just the size of the anodes 204 and returns until the ionic second pathway begins to dominate, transitioning to the second time period. The ionic process results in decreasing metallic radius in the one or more anodes.

The Heaviside function, H(x), marks the transition time between the backfill dominated circuit path of the first time period and the ionic-dominated circuit path of the second time period. The Heaviside function equals 0 for x<0, and 1 for x>0. This results in the decrease of the backfill “radius” until zero at a time Tₜᵣₐₙₛᵢₜᵢₒₙ, at which point the anode radius begins to decrease.

$${r}_{combined} = ( 1 - H ( t - {T}_{transition} ) ) \cdot {r}_{backfill} + {r}_{{o}_{anode}} - H ( t - {T}_{transition} ) \cdot {r}_{anode}$$

With the backfill and anode contributions as follows:

$${r}_{backfill} = {r}_{{o}_{backfill}} [ \frac{t - {T}_{commissioning}}{{T}_{transition} - {T}_{commissioning}} ] \\ {r}_{anode} = {r}_{{o}_{anode}} [ \frac{t - {T}_{transition}}{{T}_{end - of - life} - {T}_{transition}} ] .$$

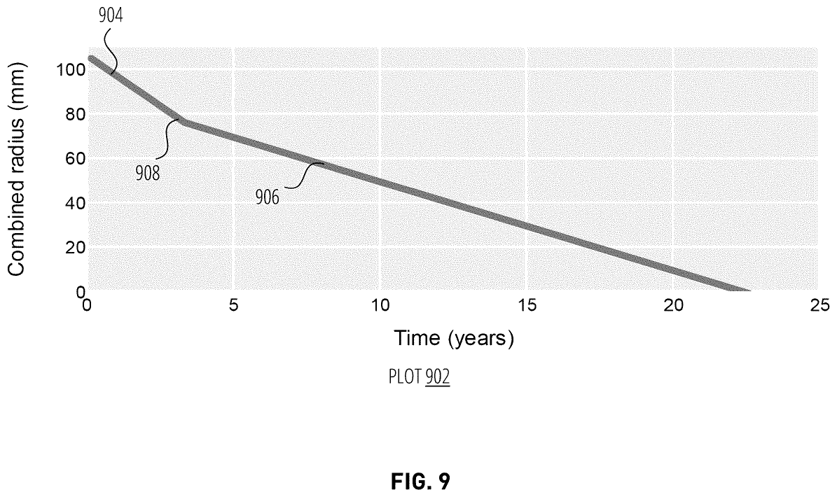

This results in a modified combined radius profile as shown in FIG. 9, which includes the initial contribution of the anode (r_{anode}) and the additional radius provided by backfill 216 (r_{backfill}). This equation introduces the variable Tₜᵣₐₙₛᵢₜᵢₒₙ, which represents the time of transition between the first pathway time period and the second pathway time period, which occurs at year 4. Plot 902 shown in FIG. 9 illustrates resistance values during the backfill-dominant electrolytic pathway period 904, resistance values during the ionic conduction-dominant pathway period 906 and the transition 908 therebetween.

With the model modified to include the contribution of backfill 216, voltage values 102 and current values 104, or resistance values determined therefrom, may be introduced to make predictions for end-of-life of the anode ground bed 206.

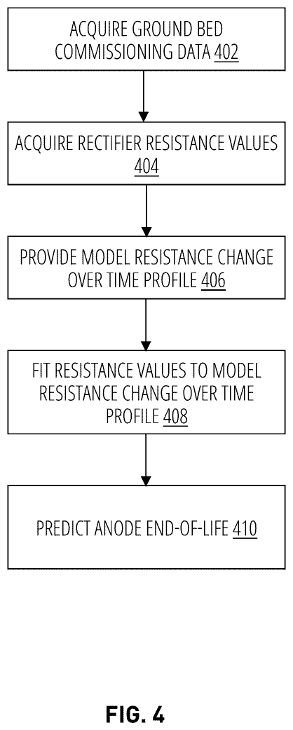

In FIG. 4, there is illustrated a method for predicting end-of-life of an anode in a cathodic protection system ground bed. The method for estimating ground bed end-of-life includes fitting rectifier data, such as voltage values 102, current values 104 or resistance values calculated therefrom, to a model of resistance changes over time.

At block 402, ground bed commissioning data is acquired (e.g., via commissioning data acquisition module 302). The ground bed commissioning data includes anode radius at time of commissioning, ground bed geometry, soil resistivity profile and ground bed backfill data.

At block 404, resistance values are acquired from a rectifier electrically coupled with the ground bed (e.g., via resistance value acquisition module 304). As previously described, seasonal changes in soil resistivity as well as work performed on the cathodic protection system, such as proactive rectifier tap changes, result in different current and voltage rates and hence different anode consumption rates over time. Surveys of voltage measurements and current measurements at the rectifier are conducted on a periodic basis, such as annually. This provides insight into year-over-year changes in anode consumption. The remote monitoring unit 110 allows for more frequent readings of rectifier current values 104, typically once weekly. This provides a much more accurate calculation of anode consumption over time. For ground beds with seasonal variation, it is preferred that the changing current over time be modeled to accurately predict the remaining anode life. If annual survey data was collected during late winter, where currents are typically lowest, and seasonal changes ignored, the anode consumption would be under-estimated, whereas if annual survey data was collected in late summer an over-estimate of consumption would be made. In one aspect, the resistance values are calculated from rectifier voltage values 102 and current values 104 using Ohm's Law:

$$R = \frac{V}{I}$$

where R is resistance, V is voltage and I is current.

At block 406, there is provided a model resistance change over time profile based on the ground bed commissioning data. The model resistance change over time profile includes a first trend wherein resistance values increase gradually and linearly, associated with resistance values from the backfill-dominant electrolytic pathway first time period. The first trend transitions to a second trend wherein resistance values increase rapidly and non-linearly, associated with resistance values from the ionic conduction-dominant pathway second time period.

At block 408, the acquired resistance values are fit to the simulated resistance change over time profile (e.g., via fitting module 308).

At block 410, end-of-life of the anode ground bed 206 is predicted as a time or time period in the modeled second trend when the model resistance change over time profile increases over a predetermined amount (e.g., via end-of-life prediction module 310). In one aspect, the end-of-life of the anode is output as an end-of-life date corresponding to the time or time period in the modeled second trend when the model resistance change over time profile increases over a predetermined amount. In one aspect, the increase is represented as the model resistance change over time profile approaches infinity.

In FIG. 10, there is shown a plot 1002 having a model resistance change over time profile 1010 with a first trend 1004 of model resistance values, a second trend 1006 of model resistance values, and a transition 1008 between the first trend 1004 and second trend 1006. Fit to the model resistance change over time profile 1010 are acquired resistance values which may be acquired directly from a rectifier 106 at a rectifier site 108 or which may be calculated by way of Ohm's Law using voltage values 102 and current values 104 collected from the rectifier 106. In this exemplary representation, predicted end-of-life 1012 for the associated anode ground bed 206, including singular anodes, multiple anodes or the composite anode provided by the anode(s) and ground bed, as the case may be, is estimated to be January 2033.

While the invention has been described in terms of specific embodiments, it is apparent that other forms could be adopted by one skilled in the art. For example, the methods described herein could be performed in a manner which differs from the embodiments described herein. The steps of each method could be performed using similar steps or steps producing the same result, but which are not necessarily equivalent to the steps described herein. Some steps may also be performed in different order to obtain the same result. Similarly, the apparatuses and systems described herein could differ in appearance and construction from the embodiments described herein, the functions of each component of the apparatus could be performed by components of different construction but capable of a similar though not necessarily equivalent function, and appropriate materials could be substituted for those noted. Accordingly, it should be understood that the invention is not limited to the specific embodiments described herein. It should also be understood that the phraseology and terminology employed above are for the purpose of disclosing the illustrated embodiments, and do not necessarily serve as limitations to the scope of the invention.

What is claimed is:

1. A method for predicting end-of-life of an anode ground bed of a cathodic protection system having at least one anode embedded in backfill material, comprising the steps of:
acquiring ground bed commissioning data, including anode radius at time of commissioning, ground bed geometry, soil resistivity profile and ground bed backfill data;
acquiring resistance values from a rectifier electrically coupled with the anode ground bed;
providing a model resistance change over time profile based on the ground bed commissioning data, the model resistance change over time profile including a first trend wherein resistance values increase gradually and linearly transitioning to a second trend wherein resistance values increase rapidly and non-linearly;
fitting acquired resistance values to the model resistance change over time profile; and,
predicting end-of-life of the anode ground bed as a time in the modeled second trend when the predicted resistance change over time profile increases over a predetermined amount.

2. The method of claim 1 wherein the model resistance change over time profile is provided by inputting the ground bed commissioning data to a model which, based on the ground bed commissioning data, defines the first trend, the second trend and transition therebetween of the model resistance change over time profile.

3. The method of claim 1 wherein end-of-life of the anode ground bed is output as an end-of-life date corresponding to the time in the modeled second trend when the predicted resistance change over time profile increases over a predetermined amount.

4. The method of claim 1 wherein the predicted resistance change over time profile during the modeled first trend transitioning into the modeled second trend has a sinusoidal pattern.

5. The method of claim 4 wherein the sinusoidal pattern is primarily due to variation of soil temperature local to the ground bed.

6. The method of claim 1 wherein acquiring resistance values includes the steps of:
acquiring voltage values from the rectifier;
acquiring current values from the rectifier; and,
calculating the resistance values from the voltage values and the current values using Ohm's Law.

7. The method of claim 1 wherein the modeled first trend is modeled based on resistance values in a first conduction path from an anode surface of the at least one anode through the backfill material and the modeled second trend is modeled based on resistance values in a second conduction path from the anode surface of the at least one anode to surrounding electrolyte.

8. The method of claim 7 wherein modeled consumption of the backfill material results in transition from the modeled first trend to the modeled second trend.

9. The method of claim 7 wherein the first conduction path and the second conduction path are in parallel.

10. The method of claim 1 wherein the ground bed geometry further includes ground bed orientation.

11. The method of claim 10 wherein the ground bed orientation is one of vertical single, horizontal single deep, vertical distributed, and vertical deep.

12. The method of claim 1 wherein end-of-life of the anode is predicted as a time in the modeled second trend when the modeled resistance change profile approaches infinity.

13. A system for predicting end-of-life of an anode ground bed of a cathodic protection system having at least one anode embedded in backfill material, comprising:
a commissioning data acquisition module for acquiring ground bed commissioning data, including anode radius at time of commissioning, ground bed geometry, soil resistivity profile and ground bed backfill data;
a resistance value acquisition module for acquiring resistance values from a rectifier electrically coupled with the anode ground bed;
a profile module for providing a model resistance change over time profile based on the ground bed commissioning data, the model resistance change over time profile including a first trend wherein resistance values increase gradually and linearly transitioning to a second trend wherein resistance values increase rapidly and non-linearly;
a fitting module for fitting acquired resistance values to the model resistance change over time profile; and,
an end-of-life prediction module configured to predict end-of-life of the anode as a time in the modeled second trend when the model resistance change over time profile increases over a predetermined amount.

14. The system of claim 13 wherein the profile module is in data exchange communication with a model which receives the ground bed commissioning data as input which, based on the ground bed commissioning data, defines the first trend, the second trend and transition therebetween of the model resistance change over time profile.

15. The system of claim 13 wherein end-of-life of the anode ground bed is output as an end-of-life date corresponding to the time in the modeled second trend when the model resistance change over time profile increases over a predetermined amount.

16. The system of claim 13 wherein the model resistance change over time profile during the modeled first trend transitioning into the modeled second trend has a sinusoidal pattern.

17. The system of claim 16 wherein the sinusoidal pattern is primarily due to variation of soil temperature local to the ground bed.

18. The system of claim 13 wherein the resistance values are calculated using Ohm's Law from paired voltage values and current values received from the rectifier.

19. The system of claim 13 wherein the modeled first trend is modeled based on resistance values in a first conduction path from an anode surface of the at least one anode through a backfill material and the modeled second trend is modeled based on resistance values in a second conduction path from the anode surface of the at least one anode to surrounding electrolyte.

20. The system of claim 19 wherein modeled consumption of the backfill material results in transition from the modeled first trend to the modeled second trend.

21. The system of claim 19 wherein the first conduction path and the second conduction path are in parallel with one another.

22. The system of claim 13 wherein the ground bed geometry further includes ground bed orientation.

23. The system of claim 22 wherein the ground bed orientation is one of vertical single, horizontal single deep, vertical distributed, horizontal shallow, vertical deep.

24. The system of claim 13 wherein the prediction module predicts end-of-life of the anode as a time in the modeled second trend when the modeled resistance change profile approaches infinity.

25. A method for predicting end-of-life of an anode embedded within a backfill material of a cathodic protection system ground bed, comprising the steps of:
acquiring ground bed commissioning data, including anode radius at time of commissioning, ground bed geometry, soil resistivity profile and ground bed backfill data;
acquiring resistance values from a rectifier electrically coupled with the anode;
providing a model resistance change over time profile based on the ground bed commissioning data, the model resistance change over time profile including a first trend wherein resistance values increase gradually and linearly transitioning to a second trend wherein resistance values increase rapidly and non-linearly;
fitting acquired resistance values to the model resistance change over time profile; and,
predicting end-of-life of the anode as a time in the modeled second trend when the modeled resistance change profile increases over a predetermined amount.

26. The method of claim 25 wherein the ground bed commissioning data includes backfill material data.

27. The method of claim 25 wherein end-of-life of the anode is predicted as a time in the modeled second trend when the modeled resistance change profile approaches infinity.
